(19) United States
(12) Patent Application Publication
(10) Pub. No.: US 2023/0095208 A1
(43) Pub. Date: Mar. 30, 2023

(54) CARGO CARRIER SET UP SYSTEM

(71) Applicant: NISSAN NORTH AMERICA, INC., Franklin, TN (US)

(72) Inventor: Timothy James BOWSHER, Maricopa, AZ (US)

(73) Assignee: Nissan North America, Inc.

(21) Appl. No.: 17/488,117

(22) Filed: Sep. 28, 2021

(51) Int. Cl. G07C 5/08; B60D 1/58

(52) U.S. Cl. CPC G07C 5/0816; B60D 1/58; G07C 5/0808

(57) ABSTRACT

A cargo carrier set up system is used for installing a cargo hitch mount to a vehicle. The cargo carrier set up system includes at least one air spring detector, a cargo baseline setting device, and a fault determination system. The air spring detector is configured to detect a first vehicle air spring condition of at least one air spring of the vehicle. The cargo baseline setting device is programmed to set a baseline air spring condition that is used as a reference value for determining one or more cargo carrier set up faults. The baseline air spring condition being based on the first vehicle air spring condition. The fault determination system is programmed to determine the one or more cargo carrier set up faults based on the baseline air spring condition and a second air spring condition that is detected by the air spring detector.

### BACKGROUND

### Technical Field

The present disclosure generally relates to a cargo carrier set up system. More specifically, the present disclosure relates to cargo carrier set up system for installing a cargo hitch to a vehicle.

### Background Information

When installing a cargo, such as a trailer, to a vehicle without a weight distributing hitch, the vehicle acts a class I lever with rear axle of the vehicle as a pivot point. In particular, tongue weight (e.g., downward force) is applied behind the rear axle and the vehicle's front axle is lifted upwards. The weight gain on the rear axle is a combination of the tongue weight and the amount of leveraged off the front axle. With a weight distributing hitch, the hitch ball has a spring force that allows the hitch ball to act as the fulcrum and forces weight back onto the front axle. The springs bars of the weight distributing hitch induce a large torque force into the hitch. The tighter the springs bars, the more torque is applied to the hitch, pivoting off the hitch ball. This torque force pushes the front axle of the vehicle downwards. As the front axle is pushed down, the rear axle can lift upwards so to reduce the load on the rear axle.

### SUMMARY

In view of the state of the known technology, one aspect of the present disclosure is to provide a cargo carrier set up system used for installing a cargo hitch mount to a vehicle. The cargo carrier set up system comprises at least one air spring detector, a cargo baseline setting device, and a fault determination system. The air spring detector is configured to detect a first vehicle air spring condition of at least one air spring of the vehicle. The cargo baseline setting device is programmed to set a baseline air spring condition that is used as a reference value for determining one or more cargo carrier set up faults. The baseline air spring condition being based on the first vehicle air spring condition. The fault determination system is programmed to determine the one or more cargo carrier set up faults based on the baseline air spring condition and a second air spring condition that is detected by the air spring detector.

### BRIEF DESCRIPTION OF THE DRAWINGS

Referring now to the attached drawings which form a part of this original disclosure:

FIG. 1 is a schematic view of a vehicle equipped with a cargo carrier set up system in accordance with an illustrated embodiment;

FIG. 2 is a block diagram of the cargo carrier set up system;

FIG. 3 is a side view of the vehicle that is hitched to a cargo via a weight distributing hitch with the vehicle's rear axle being overloaded;

FIG. 4 is a side view of the vehicle that is hitched to the cargo via the weight distributing hitch with the vehicle's front axle being overloaded;

FIG. 5 is a schematic diagram showing an example of a display device of the cargo carrier set up system during real axle check;

FIG. 6 is a schematic diagram showing an example of the display device of the cargo carrier set up system during front axle check;

FIG. 7 is a flowchart of an initial trailer set up process of the cargo carrier set up system;

FIG. 8 is a flowchart of a trailer connected process of the cargo carrier set up system;

FIG. 9 is a flowchart of a rear axle check of the cargo carrier set up system; and

FIG. 10 is a flowchart of a front axle check of the cargo carrier set up system.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

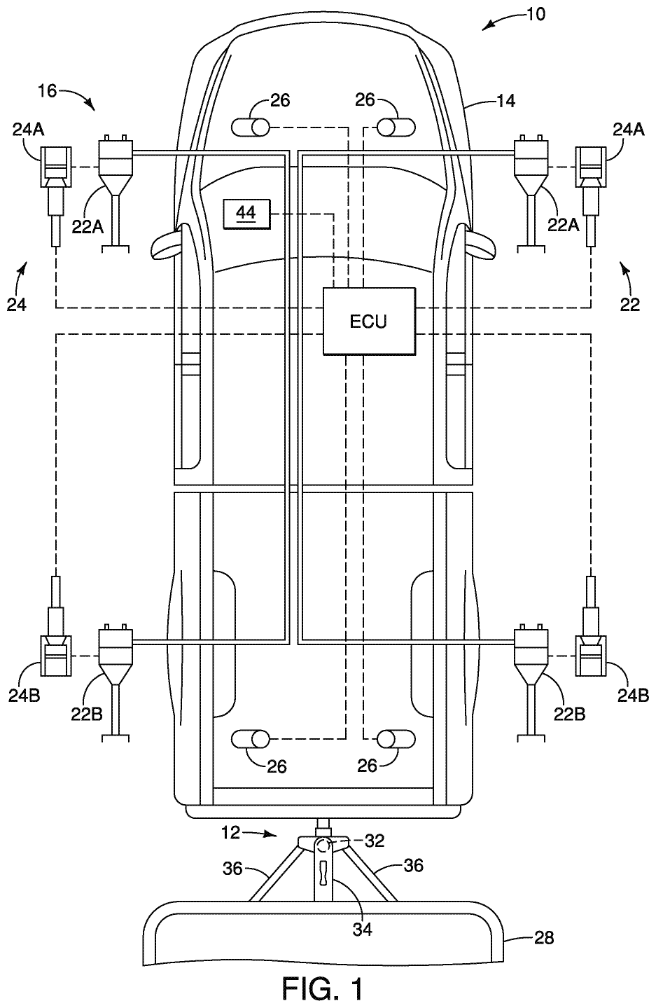

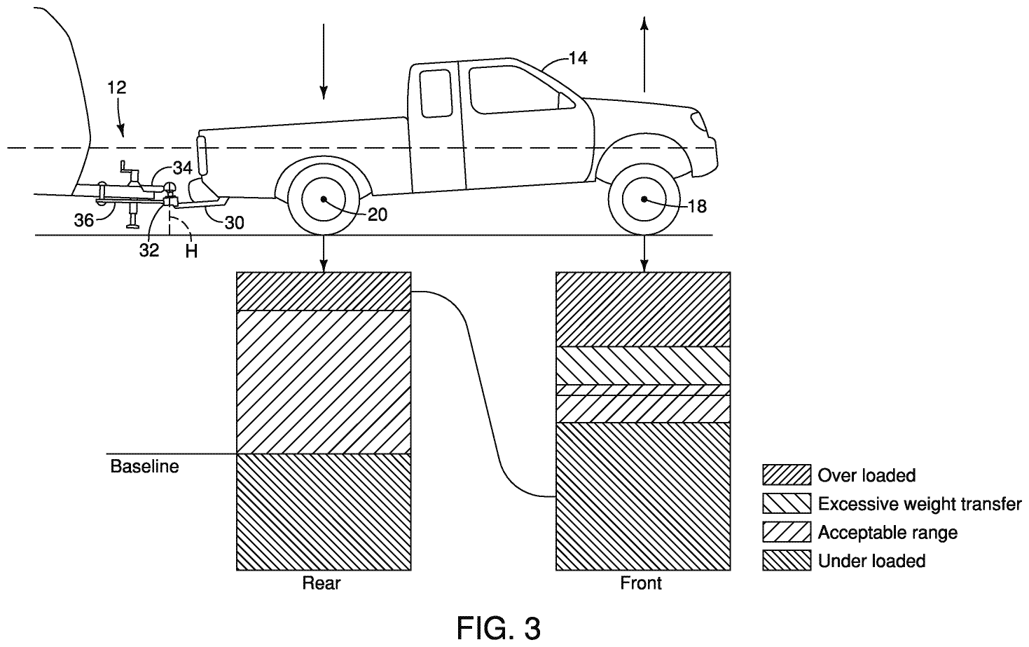

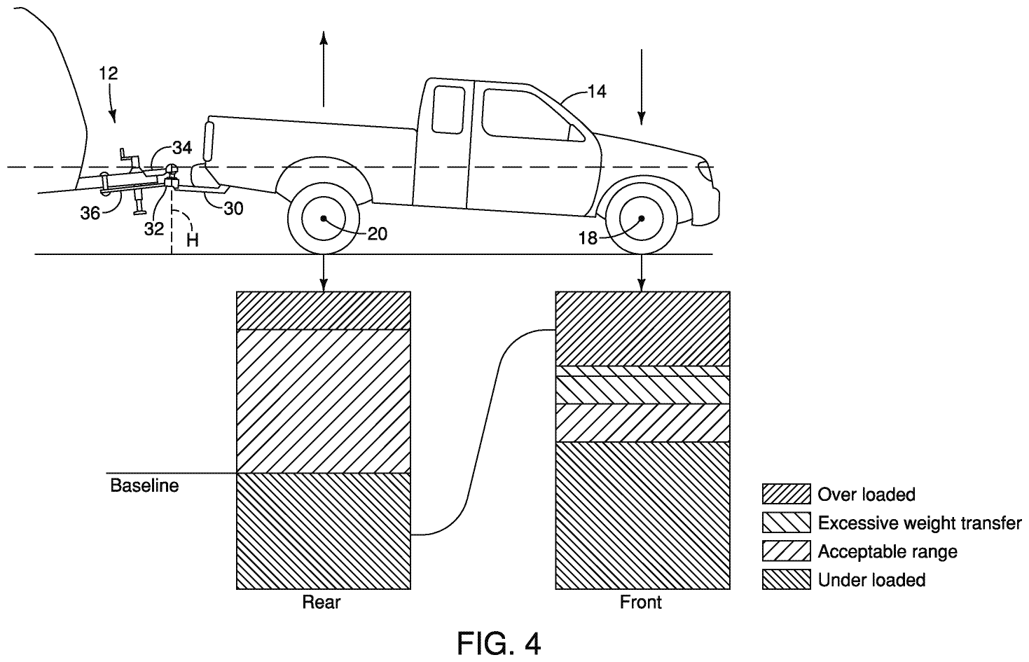

Referring initially to FIG. 1, a cargo carrier set up system 10 for installing a cargo hitch mount 12 to a vehicle 14 is illustrated in accordance with an illustrated embodiment. The vehicle 14 is equipped with an air suspension system 16 that is used for heavy vehicles, such as buses, semi-trailers and trucks (pickup truck illustrated herein). In particular, the suspension system 16 is powered by an electric or engine-driven air pump or compressor (not shown). The compressor pumps the pressurized air into a flexible bellows, usually made from textile-reinforced rubber, to inflate the bellows and raise the vehicle's 14 chassis from the vehicle's 14 front and rear axles 18 and 20 (front and rear axles 18 and 20 shown schematically in FIGS. 3 and 4).

The vehicle 14 is equipped with suspension airbags on all for corners of the vehicle 14 for providing air lift for the vehicle 14. The suspension system 16 uses air springs 22 provided at the airbags (only air springs 22 shown in FIG. 1 for simplicity). The air springs 22 are enclosed in a vulcanized rubber or plastic membrane so that the air springs 22 can be inflated or deflated to maintain the vehicle's 14 trim height. Therefore, the cargo carrier set up system 10 comprises at least one air spring 22. In particular, as shown in FIG. 1, the cargo carrier set up system 10 includes a pair of front air springs 22A provided at the front wheels and a pair of rear air springs 22B at the rear wheels.

The suspension system 16 further includes a plurality of air pipes connecting a storage tank (not shown) to the air springs 22 that channel the flow of air throughout the suspension system 16. The air bags are further equipped with integrated air spring solenoids (not shown). The solenoids are valves that regulate the amount of air in the air springs 22 based on the height of the vehicle 14 from the ground. Thus, the solenoids let in or release air from the air springs 22 to bring the vehicle 14 to a desired height with respect to the ground. Therefore, adjustment of the air springs 22, by adding or releasing air from the air springs 22, will adjust the height of the vehicle 14 with respect to the ground.

In the illustrated embodiment, the suspension system 16 is provided with pressure transducers 24 at each of the air springs 22 to detect the pressure or weight of the air springs 22. The air springs 22 measure information regarding the condition of the airbags (e.g., the pressure and weight inside the airbags). The pressure transducers 24 are conventional transducers that convert the pressure information to a readable signal.

The pressure transducers 24 are in electronic communication to send and receive the airbag condition information to a central electronic controller (hereinafter ECU) of the cargo carrier set up system 10. The ECU controls the electronic components of the cargo carrier set up system 10 and the suspension system 16, as will be further discussed below. Preferably, the cargo carrier set up system 10 is integrated with the suspension system 16 of the vehicle 14 such that the ECU is in electronic communication with the components of both the cargo carrier set up system 10 and the suspension system 16.

In the illustrated embodiment, the pressure transducers 24 can be considered air spring detectors of the cargo carrier set up system 10 that detect the condition of the airbags via the air springs 22. Therefore, the cargo carrier set up system 10 comprises at least one spring detector (e.g., the pressure transducers 24). As best seen in FIG. 1, the pressure transducers 24 includes a pair of front air spring detectors 24A and a pair of rear air spring detectors 22B. The pair of front air spring detectors 24A and the pair of rear air spring detectors 24B correspond to the front and rear air springs 22A and 22B, respectively.

The cargo carrier set up system 10 of the illustrated embodiment is provided with the vehicle 14 that is equipped with the suspension system 16. The suspension system 16 of the illustrated embodiment is a conventional suspension system 16 for heavy duty vehicles. However, the suspension system 16 further includes the front and rear air spring detectors 24A and 24B (e.g., the pressure transducers 24) provided at the air springs 22 to send and receive the conditions of the airbags/air springs 22. The pressure transducers 24 provide information on the conditions of the air springs 22 in order to inform the cargo carrier set up system 10.

As also seen in FIG. 1, the vehicle 14 is further equipped with height detectors 26 that are part of the suspension system 16 and are integrated with the cargo carrier set up system 10. The height detectors 26 are sensors fitted between the chassis and the suspension system 16 to measure ride height of the vehicle 14.

Thus, the cargo carrier set up system 10 further comprises at least one height detector 26 configured to determine a ride height of the vehicle 14. As shown, the cargo carrier set up system 10 preferably includes four height detectors 26 that are located at the four corners of the vehicle 14 to detect an absolute height reference for each corner of the vehicle 14. The height detectors 26 can detect resistance in contact with the terrain on all four of the vehicle's 14 corners to provide height reference for all corners.

Referring to FIGS. 1, 3 and 4, the vehicle 14 of the illustrated embodiment is configured to be coupled to the cargo hitch mount 12 so that the vehicle 14 can pull cargo 28, such as a trailer. Therefore, the hitch mount 12 is provided to the vehicle 14. The hitch mount 12 includes a shank 30 having a socket that supports a ball mount 32. The ball mount 32 is configured to accept a coupler 34 from the cargo 28. The hitch mount 12 is preferably a weight distributing cargo hitch that includes a pair of spring bars 36 that extend from the ball mount 32 towards the cargo 28.

The coupler 34 and the ball mount 32 engage with each other at the desired trailer height. In the illustrated embodiment, the hitch mount 12 is a trailer hitch mount, and the coupler 34 is a trailer coupler. However, it will be apparent to those skilled in the vehicle 14 field from this disclosure that the cargo carrier set up can be implemented with other types of hitch mounts and couplers, as needed and/or desired.

Conventionally, when installing a cargo hitch to a vehicle, the hitch mount and the coupler are installed to each other based on a trailer ride height, which is the distance measured between the ground and the top of the trailer coupler with the trailer parallel to the ground. However, conventional suspension systems, will automatically self-adjust the trailer ride height when the hitch mount and the coupler are installed to each other. That is, the trailer ride height will be measured to be the same regardless of the load distribution. The self-adjustment of the suspension system prevents the conventional trailer ride height measurement from being an accurate gauge for properly setting the spring bars for the hitch mount. In other words, the trailer ride height cannot accurately gauge the weight distribute or load distribution of the vehicle and the cargo due to the varying ride trailer height.

Due to this problem, a conventional vehicle's suspension system can be overloaded or underloaded at the axles, but the overload and underload state cannot be detected just by measuring the trailer ride height. The overloaded or underloaded state can only be detected by the pressure of the air springs. Further, the changing ride height will change the loading on the spring bars of the hitch mount.

Proper load distribution among the front and rear axles 18 and 20 of the vehicle 14 is important during cargo set up. The vehicle 14 is overloaded if a portion of the maximum payload of the vehicle 14 is on a single axle. For example, if the rear axle 20 is overloaded (e.g., carrying too much of the total load), the front axle 18 does not exert enough weight against the driving surface, such as the condition seen in FIG. 3. Similarly, when the front axle 18 is overloaded, the rear axle 20 does not exert enough weight against the driving surface, such as the condition seen in FIG. 4. Both of these conditions can cause premature wear and tear on components of the suspension system 16 and the tires.

Adjustment of the spring bars 36 on the hitch can redistribute the weight or load between the front and rear axles 18 and 20. In particular, by adjusting the springs bars to increase tension on the spring bars 36 (1) the weight on the front axle 18 is increased, (2) the weight on the rear axle 20 is decreased and (3) some of the tongue weight can be shifted rearwards to the trailer. By adjusting the spring bars 36 to decrease tension on the spring bars 36 (1) the weight on the front axle 18 is decreased and (2) the weight on the rear axle 20 is increased. Therefore, varying the torque force (e.g., the spring tension) of the spring bars 36, the weight transfer or distribution between the front and rear axles 18 and 20 can be adjusted.

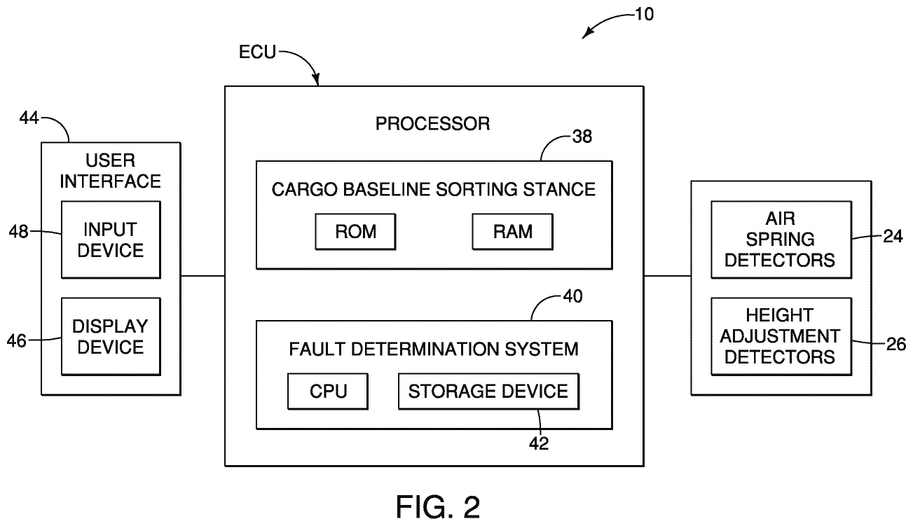

Referring to FIG. 2, the cargo carrier set up system 10 of the illustrated embodiment is provided to help the vehicle 14 user set up the hitch mount 12 to have a load condition that accurately reflects the load condition of the vehicle 14 when the vehicle 14 is hitched with the cargo 28 during driving. Thus, in the illustrated embodiment, the cargo carrier set up system 10 further comprises a cargo baseline setting device 38 and a fault determination system 40. In particular, the cargo carrier set up system 10 is configured to provide the user with a recommended cargo setting for hitching the cargo to the vehicle 14, as will be further described below.

Referring to FIGS. 1 and 2, the cargo carrier set up system 10 is performed using hardware and software. Possible examples of the hardware include the air spring detectors 24A and 24B (along with the air springs 22) and the height detectors 26. Additionally, hardware can further include the ECU, as seen in FIG. 2. The ECU can be integrated with other sensors/detectors that are generic to a conventional modern vehicle 14 that are not illustrated herein, such as door sensors, ignition detector, etc.

As seen in FIG. 2, the ECU of the cargo carrier set up system 10 includes a microcomputer having a processor. The processor is equipped with a central processing unit (CPU) and a storage device 42. The storage device 42 (i.e., a computer memory device) can be any a non-transitory computer readable medium such as a ROM (Read Only Memory) device, a RAM (Random Access Memory) device, a hard disk, a flash drive, etc. For example, the storage device 42 can be nonvolatile memory, volatile memory or any computer readable medium with the sole exception of a transitory, propagating signal. The storage device 42 is configured to store settings, programs, data, calculations and/or results of the processor(s).

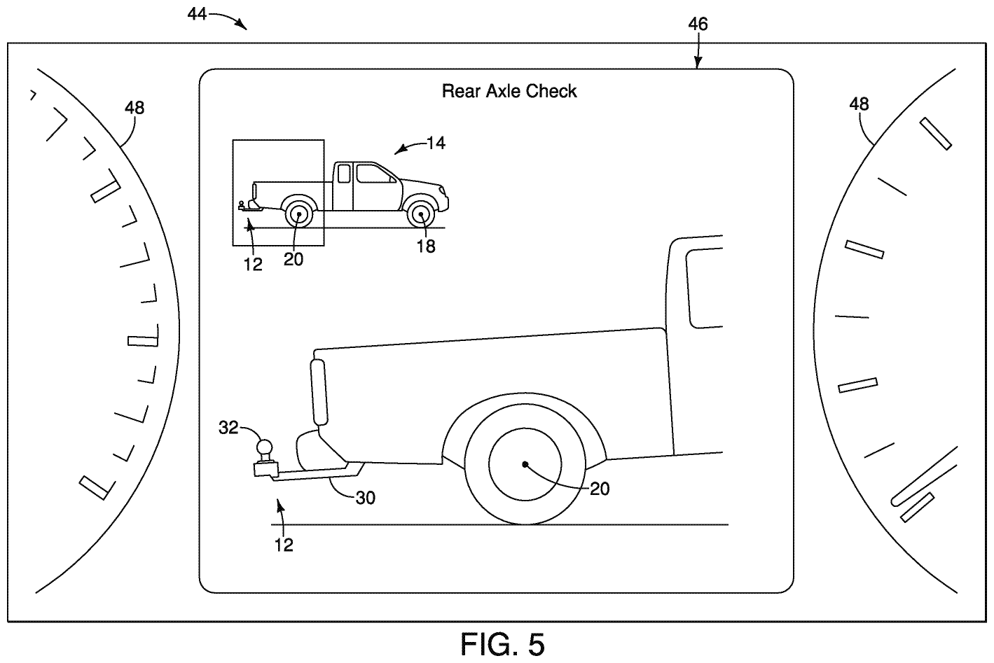

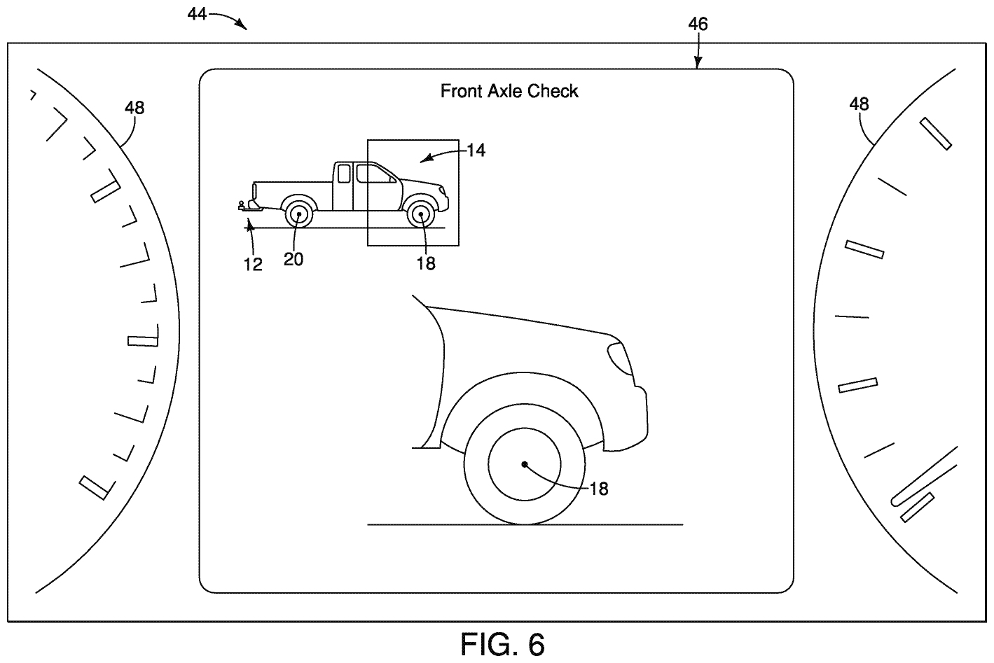

As seen in FIG. 2, the cargo carrier set up system 10 further comprises a notification system 44 programmed to notify the user of faults detected during cargo carrier set up. The notification system 44 is electrically connected to the processor. The notification system 44 includes a user interface defined by a display device 46 and an input device 48. The display device 46 is installed on the vehicle 14, such as on the dashboard or on the vehicle's 14 instrument panel. The input device 48 allows the user to input information to the cargo carrier set up system 10. The display device 46 can include a display screen, such as seen in FIGS. 5 and 6. The input device 48 can include buttons or dials that is operable by the driver. Alternatively, the display screen can be a touch screen such that the display screen itself operates as the input device 48.

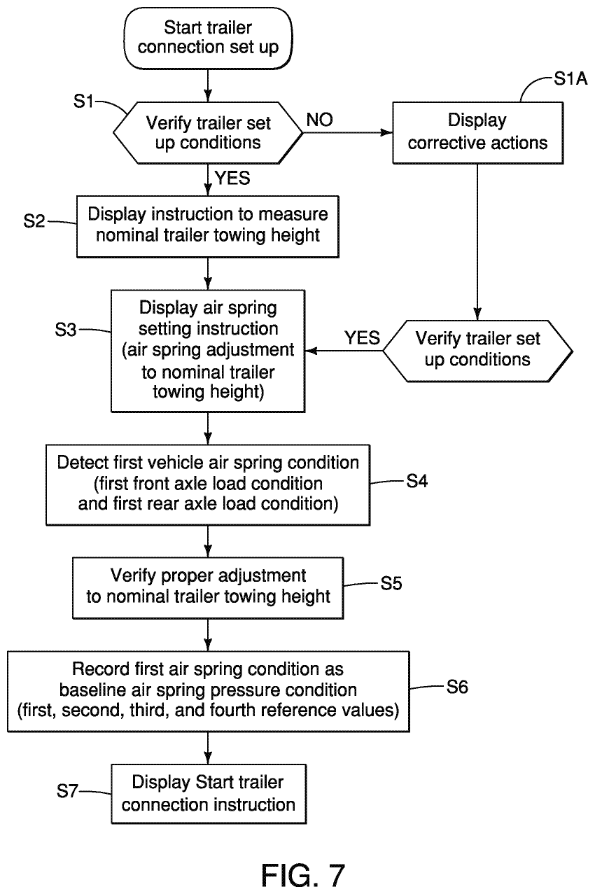

Referring to FIG. 7, during cargo carrier set up, the driver can select an initial trailer set up process of the cargo carrier set up system 10 by inputting instructions into the input device 48. Therefore, the ECU of the cargo carrier set up system 10 can initiate an initial trailer set up process. In step S1, the ECU will verify that set up conditions are met. In the illustrated embodiment, verifying set up conditions can include verifying that the doors are closed, the engine is running properly, the vehicle 14 is parked on even plane, the suspension system 16 is parallel to the ground, etc. If the trailer set up conditions are not verified, the display device 46 can display corrective actions to the driver in step S1A (e.g., close doors, repark vehicle 14, restart engine, etc.).

Once the set up conditions are verified as being met, the ECU instructs the display device 46 to display an instruction to measure the nominal trailer towing height H in step S2. In the illustrated embodiment, the nominal trailer towing height H is defined as the distance between the coupler 34 and the ground. Preferably, the nominal trailer towing height H is measured between the ground and the top of the coupler 34, as seen schematically in FIG. 3. However, the nominal trailer towing height H can also be measured based on a distance between the bottom of the coupler 34 and the ground. Typically, the nominal trailer towing height H is approximately 17 inches based on the manufacture design of the vehicle 14.

The ECU than instructs the display device 46 to display an air spring setting instruction to the driver in step S3. In the illustrated embodiment, the air spring setting instruction instructs the driver to adjust the air springs 22 to the nominal trailer towing height H. That is, the air springs 22 of the vehicle 14 are to be adjusted so that the suspension system 16 (e.g., the front and rear axles 18 and 20) has a height from the ground that corresponds to the distance between the coupler 34 and the ground. The air springs 22 are adjusted so that the suspension system 16 has a height that corresponds to the height of the coupler 34 (e.g., the trailer) prior to the cargo being hitched to the vehicle 14.

After adjustment, the ECU transmits a signal to the air spring detectors to detect the pressure in the air springs 22 in step S4. That is, the air spring detectors detect a first vehicle air spring condition of the air springs 22 in step S4. The air spring detectors can detect the load on the front and rear axles 18 and 20 prior to the cargo being hitched to the vehicle 14, which is the first air spring condition. The first vehicle air spring condition is a condition of the air springs 22 that determined is prior to a time when the cargo hitch mount 12 is installed to the vehicle 14.

Preferably, the first vehicle air spring condition includes a first front axle load condition that are detected by the front air spring detectors 24A. The first vehicle air spring condition preferably further includes a first rear axle load condition that is determined by the pair of rear air spring detectors 22B. Thus, the first front and rear axle load conditions are determined by the pair of front and rear air spring detectors 24A and 24B prior to the time when the cargo hitch mount 12 is installed to the vehicle 14.

The ECU sends a signal to the air spring detectors 24A and 24B to verify that the suspension system 16 (e.g., the front and rear axles 18 and 20) have been adjusted properly in step S5.

The detected first air spring condition of the air springs 22 is then stored in step S6. The first vehicle air spring condition can be stored in the storage device 42 (e.g., the ROM) of the ECU that is a computer-readable storage medium. In particular, the cargo baseline setting device 38 stores the first vehicle air spring condition as a baseline air spring condition. The baseline air spring condition is used as a reference value for determining one or more cargo carrier set up faults, as will be further discussed below. Therefore, the cargo baseline setting device 38 of the illustrated embodiment can include the storage device 42 of the cargo carrier set up system 10.

Therefore, in the illustrated embodiment, the baseline air spring condition is based on the first vehicle air spring condition. The baseline air spring condition includes a first reference value that is based on a condition of one of the rear air springs 22B. The baseline air spring condition further includes a second reference value that is based on a condition of the other one of the rear air springs 22B. The baseline air spring condition further includes a third reference value that is based on a condition of one of the front air springs 22A. The baseline air spring condition further includes a fourth reference value that is based on a condition of the other one of the front air springs 22A.

In the illustrated embodiment, the first, second, third and fourth reference values are each determined based on a predetermined value. In particular, the first, second, third and fourth reference values are determined based on the nominal trailer towing height H that was determined in step S2. In other words, the nominal trailer towing height H is the predetermined value for determining the first, second, third and fourth reference values. The first, second, third and fourth reference values are stored in the storage device 42 by the cargo baseline setting device 38 in step S6.

As seen in FIGS. 3 and 4, the front axle 18 has a larger range for an underloaded condition than the rear axle 20. Therefore, the ECU preferably calculates a 90% threshold for the third and fourth reference values for the front air springs 22A. That is, the ECU calculates a 90% value of the third and fourth reference values to be prestored in the storage device 42.

The ECU then instructs the display device 46 to display a start trailer connection instruction in step S7. Therefore, the driver is instructed to now connect the hitch mount 12 and the coupler 34. Therefore, the notification system 44 is programmed to notify a vehicle 14 user that the cargo hitch mount 12 can be installed to the vehicle 14 only after the first, second, third and fourth reference values are determined. The first, second, third and fourth reference values are each determined by detecting a condition of the front air springs 22A and a condition of the rear air springs 22B after the of front air springs 22A and the rear air springs 22B are adjusted to correspond to the predetermined nominal cargo towing height.

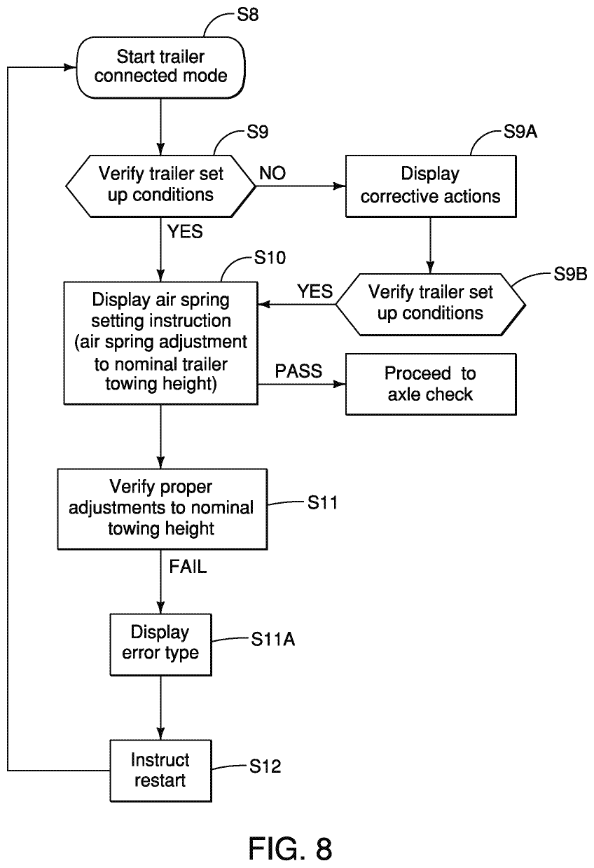

Referring to FIG. 8, the driver initiates a trailer connected process of the cargo carrier set up system 10 once the hitch mount 12 and the coupler 34 are installed in step S8. In step S9, the ECU will again verify that set up conditions are met (e.g., the doors are not closed, the engine is running properly, vehicle 14 parked on even plane, suspension is parallel to the ground, etc.). If these conditions cannot be met, the display device 46 can display corrective actions to the driver in step S9A (e.g., close doors fully, restart engine, etc.). The ECU can perform this step by sending an instruction to the height detectors 26 and the engine detectors, door closure detectors of the vehicle 14 to detect the states of these components.

Once the set up conditions are verified as being met in step S9B, the display device 46 then displays an air spring setting instruction to the driver in step S10. In the illustrated embodiment, the air spring setting instruction instructs the driver to adjust the air springs 22 to the nominal trailer towing height H that was previously measured in step S2. That is, the cargo carrier set up system 10 instructs the driver to adjust the air springs 22 so that the suspension system 16 (e.g., the front and rear axles 18 and 20) has a height from the ground that corresponds to the distance between the coupler 34 and the ground when the cargo 28 was not hitched to the vehicle 14.

The ECU sends a signal to the height detectors 26 and the air spring detectors to verify that the suspension system 16 (e.g., the front and rear axles 18 and 20) have been adjusted properly. That is, the ECU verifies that air springs 22 have been properly adjusted to the nominal trailer towing height H in step S11.

If the air springs 22 cannot be adjusted, the ECU instructs the display device 46 to display an error type (e.g., suspension is not parallel to the ground, suspension misalignment) in step S11A. Detection of this type of error can be achieved by information detected by the height detectors 26 and the air spring detectors 24A and 24B.

The ECU will instruct the display device 46 to display restart instructions once the errors have been rectified in step S12.

If the air springs 22 have adjusted the suspension system 16 to the nominal trailer towing height H, then the ECU enables the user to proceed to the axle checks in step S13.

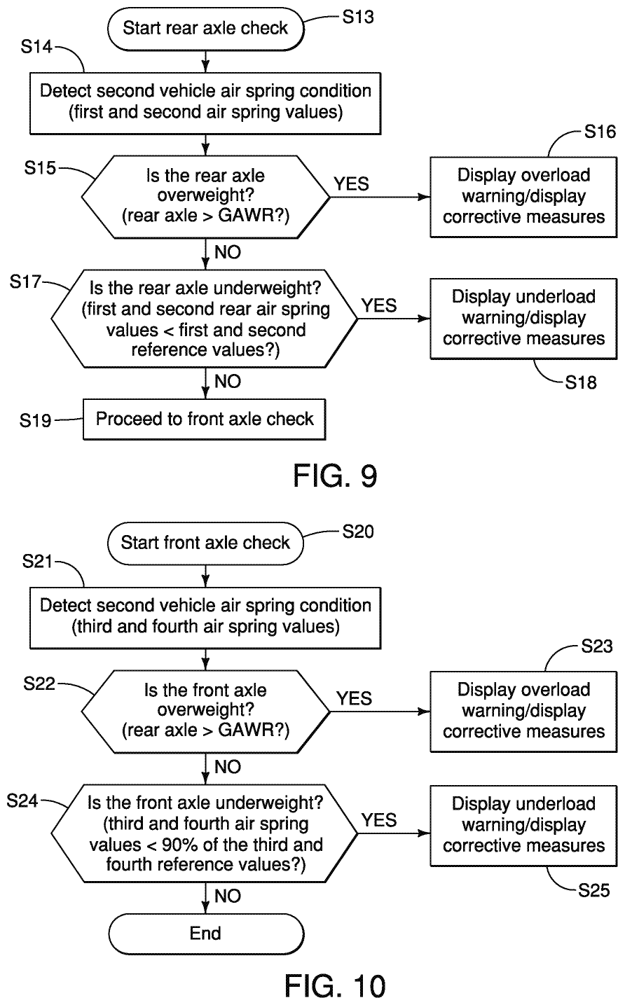

Referring to FIG. 9, the fault determination system 40 of the cargo carrier set up system 10 will now be discussed. The fault determination system 40 is a program of the cargo carrier set up system 10. In particular, the fault determination system 40 is programmed to determine the one or more cargo carrier set up faults (e.g., an overload condition of the front or rear axles 18 and 20, an underload condition of the front or rear axles 18 and 20). The fault determination system 40 includes the ECU having the processor(s) and the storage device 42(s).

The ECU of the fault determination system 40 initiates a rear axle 20 check in step S13. The ECU instructs the rear air spring detectors 22B to detect the pressure of the rear air springs 22B now that the cargo 28 is hitched to the vehicle 14, in step S14. That is, the ECU instructs the rear air springs 22B to detect a second vehicle air spring condition. In particular, the second vehicle air spring condition measures the pressure of both the rear air springs 22B. Therefore, the second vehicle air spring condition includes a first air spring value for the rear air spring and a second air spring value for the rear air spring 22B. Thus, the second vehicle air spring condition includes the a rear axle load condition (defined by the first and second air spring values) that is determined by the rear air spring detectors 22B after the time when the cargo hitch mount 12 is installed to the vehicle 14.

In step S15, the ECU compares the first and second air spring values to a gross axle weight rating (GAWR) to determine whether the rear axle 20 is overweight. In the overweight condition, there is too much load on the suspension system 16, the tires and the brakes. The GAWR is a specific weight determined by the manufacturer to be the maximum allowable weight that can be placed on an individual axle for the vehicle 14. The GAWR is a pre-stored value in the storage device 42 of the cargo carrier set up system 10, such as in the RAM or ROM.

If the first and second air spring values exceeds the GAWR, then the ECU instructs the display device 46 to display an overload warning message in step S16. Therefore, the fault determination system 40 determines a rear axle overload condition by comparing the second front axle load condition with at least one of the first and second reference values with a prestored weight value (the GAWR). The ECU also instructs the display device 46 to display corrective measures. In particular, the display device 46 can display and instruction to increase the tension on the hitch springs by tightening the spring bars 36 in step S16.

The ECU also compares the first and second air spring values to the first and second reference values, respectively in step S17 to determine whether the rear axle 20 is underweight. If the first and second rear air spring values are less than the first and second reference values respectively, the fault determination system 40 determines that the rear axle 20 is underweight. If the first and second air spring values are less the first and second reference values respectively, then the ECU instructs the display device 46 to display an underload warning message in step S18.

Therefore, the fault determination system 40 determines a rear axle 20 underload condition by comparing the second rear axle load condition with at least one of the first and second reference values. The ECU also instructs the display device 46 to display corrective measures. In particular, the display device 46 can display and instruction to decrease the tension on the hitch springs by loosening the spring bars 36.

If the ECU determines that the first and second air spring values do not exceed the GAWR and are not less than the third and fourth reference values, then the ECU allows the user to proceed to the front axle 18 check in step S19.

Referring to FIG. 10, the ECU instructs the front air spring detectors 24A to detect the pressure of the front air springs 22A, in step S20. The ECU instructs the front air springs 22A to detect values for the second vehicle air spring condition in step S21. In particular, the second vehicle air spring condition measures the pressure of both the front air springs 22A. Therefore, the second vehicle air spring condition includes a third air spring value for the front air spring and a fourth air spring value for the front air spring 22A. Thus, the second vehicle air spring condition further includes the a front axle load condition (defined by the third and fourth air spring values) that is determined by the front air spring detectors 24A after the time when the cargo hitch mount 12 is installed to the vehicle 14.

In step S22, the ECU compares the third and fourth air spring values to the prestored weight value (i.e., the GAWR) to determine whether the front axle 18 is overweight. The GAWR for the front axle 18 can be identical to the GAWR for the rear axle 20 or can be different, depending on the manufacturing make. In the overweight condition, there is too much load on the suspension system 16, the tires and the brakes. The GAWR is also a pre-stored value in the storage device 42(s) of the cargo carrier set up system 10, such as in the RAM or ROM.

If the third and fourth air spring values exceeds the GAWR, then the ECU instructs the display device 46 to display an overload warning message in step S23. Therefore, the fault determination system 40 determines a front axle overload condition by comparing the second front axle load condition with the prestored weight value. The ECU also instructs the display device 46 to display corrective measures. In particular, the display device 46 can display and instruction to decrease the tension on the hitch springs by loosening the spring bars 36.

The ECU also compares the third and fourth air spring values to the third and fourth reference values, respectively in step S24 to determine whether the front axle 18 is underweight. In particular, the compares the third and fourth air spring values to the 90% threshold value of the third and fourth reference values.

If the third and fourth air spring values are less than the 90% threshold value of the first and second reference values respectively, the fault determination system 40 determines that the front axle 18 is underweight. If the third and fourth air spring values are less than the 90% threshold value of the third and fourth reference values respectively, then the ECU instructs the display device 46 to display an overload warning message in step S25.

Therefore, the fault determination system 40 determines a front axle underload condition by comparing the second front axle load condition with at least one of the third and fourth reference values. The ECU also instructs the display device 46 to display corrective measures. In particular, the display device 46 can display and instruction to increase the tension on the hitch springs by tightening the spring bars 36 in step S26.

The notification system 44 is programmed to notify the vehicle 14 user that the vehicle 14 is ready for use with the cargo hitch mount 12 installed only after detected fault conditions are resolved.

In the illustrated embodiment, by having the baseline air spring condition (defined by the first, second, third and fourth reference values) being based on the nominal trailer towing height H that is measured before the cargo is hitched to the vehicle 14, the cargo carrier set up system 10 can eliminate the automatic height adjustment of the suspension system 16 that changes the trailer ride height between the time when the cargo is being hitched to the vehicle 14 and after driver.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the cargo carrier set up system. Accordingly, these terms, as utilized to describe the present invention should be interpreted relative to a vehicle equipped with the cargo carrier set up system.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A cargo carrier set up system for installing a cargo hitch mount to a vehicle, the cargo carrier set up system comprising:
at least one air spring detector configured to detect a first vehicle air spring condition of at least one air spring of the vehicle;
a cargo baseline setting device programmed to set a baseline air spring condition that is used as a reference value for determining one or more cargo carrier set up faults, the baseline air spring condition being based on the first vehicle air spring condition; and
a fault determination system programmed to determine the one or more cargo carrier set up faults based on the baseline air spring condition and a second air spring condition that is detected by the at least one air spring detector.

2. The cargo carrier set up system according to claim 1, wherein
the first vehicle air spring condition being a condition of the at least one air spring that determined is prior to a time when the cargo hitch mount is installed to the vehicle.

3. The cargo carrier set up system according to claim 2, wherein
the second vehicle air spring condition being a condition of the at least one air spring that is determined after a time when the cargo hitch mount is installed to the vehicle.

4. The cargo carrier set up system according to claim 3, wherein
the at least one air spring detector includes a pair of front air spring detectors and a pair of rear air spring detectors,
the at least one air spring includes a pair of front air springs and a pair of rear air springs that correspond to the front and rear air spring detectors, respectively.

5. The cargo carrier set up system according to claim 4, wherein
the first vehicle air spring condition includes a first front axle load condition that is determined by the pair of front air spring detectors prior to the time when the cargo hitch mount is installed to the vehicle,
the first vehicle air spring condition further includes a first rear axle load condition that is determined by the pair of rear air spring detectors prior to the time when the cargo hitch mount is installed to the vehicle.

6. The cargo carrier set up system according to claim 5, wherein
the baseline air spring condition includes a first reference value that is based on a condition of one the pair of rear air springs,
the baseline air spring condition further includes a second reference value that is based on a condition of another one of the pair of rear air springs,
the baseline air spring condition further includes a third reference value that is based on a condition of one of the pair of front air springs,
the baseline air spring condition further includes a fourth reference value that is based on a condition of another one of the pair of front air springs.

7. The cargo carrier set up system according to claim 6, wherein
the first, second, third and fourth reference values are each further based on a predetermined nominal cargo towing height.

8. The cargo carrier set up system according to claim 7, further comprising
at least one height detector configured to determine a suspension ride height of the vehicle.

9. The cargo carrier set up system according to claim 8, wherein
the first, second, third and fourth reference values are each determined by detecting a condition of the rear air springs and a condition of the front springs after the rear air springs and the front air springs are adjusted to correspond to the predetermined nominal cargo towing height.

10. The cargo carrier set up system according to claim 9, further comprising
a notification system having a display that is installed on the vehicle, the notification system being programmed to notify a vehicle user that the cargo hitch mount can be installed to the vehicle only after the first, second, third and fourth reference values are determined.

11. The cargo carrier set up system according to claim 9, wherein
the second vehicle air spring condition includes a second front axle load condition that is determined by the pair of front air spring detectors after the time when the cargo hitch mount is installed to the vehicle,
the second vehicle air spring condition further includes a second rear axle load condition that is determined by the pair of rear air spring detectors after the time when the cargo hitch mount is installed to the vehicle.

12. The cargo carrier set up system according to claim 11, wherein
the fault determination system determines a rear axle overload condition by comparing the second front axle load condition with a prestored weight value.

13. The cargo carrier set up system according to claim 12, wherein
the fault determination system determines a rear axle underload condition by comparing the second front axle load condition with at least one of the first and second reference values.

14. The cargo carrier set up system according to claim 13, wherein
the fault determination system determines a front axle overload condition by comparing the second front axle load condition with the prestored weight value.

15. The cargo carrier set up system according to claim 14, wherein
the fault determination system determines a front axle underload condition by comparing the second rear axle load condition with at least one of the third and fourth reference values.

16. The cargo carrier set up system according to claim 15, wherein
the notification system is programmed to notify the vehicle user that the vehicle is ready for use with the cargo hitch mount installed only after detected fault conditions are resolved.
